(19) United States
(12) Patent Application Publication
(10) Pub. No.: US 2015/0058478 A1
(43) Pub. Date: Feb. 26, 2015

(54) INFORMATION PROCESSING DEVICE LOAD TEST EXECUTION METHOD AND COMPUTER READABLE MEDIUM

(71) Applicant: NEC CORPORATION, Tokyo (JP)

(72) Inventor: Yasuhiro Ajiro, Tokyo (JP)

(73) Assignee: NEC Corporation, Minato-ku, Tokyo (JP)

(21) Appl. No.: 14/386,871

(22) PCT Filed: Mar. 18, 2013
(86) PCT No.: PCT/JP2013/001827

§ 371 Date: Sep. 22, 2014

(30) Foreign Application Priority Data
Mar. 30, 2012 (JP) 2012-079418

(51) Int. Cl. H04L 12/26

(52) U.S. Cl. CPC H04L 43/0888
USPC 709/224

(57) ABSTRACT

An information device provided with: a test storage unit that stores test scenarios that include standby time comprising multiple instances of processing in which a request is sent and response to the request is received, and in which the time between sending and receiving is time during which a TCP connection is disconnected; a generation unit that generates a load generation unit that executes a test scenario and applies a load to a system that has been designated as a target for having a load applied thereto; a parameter storage unit that stores parameters for determining the length of the standby time; a parameter adjustment unit that adjusts parameters so that the desired number of requests per unit time reach the system; and a communication control unit that disconnects the TCP connection during the standby time that is included in the test scenario which is being executed by the load generation unit.

### TECHNICAL FIELD

The present invention relates to an information processing device that executes a load test and a method of executing the load test.

### BACKGROUND ART

It is known a method called a load test that applies a pseudo load on a subject system, server, or the like as one of the methods of checking the behavior of the system, server, or the like under a high load. In many cases, the load test is executed using an information processing device (a load test execution device) that executes software called a load test tool.

The load test execution device applies a load on a test-target system, for example, by transmitting requests to the test-target system.

The test-target system processes the requests received from the load test execution device and responds to the load test execution device.

The test-target system, for example, includes a server of an on-line shopping site. The following will describe how a load is applied on the server during actual operation of an on-line shopping site.

There are many and unspecified customers for an online shopping site. Each customer accesses the online shopping site by operating a client terminal device. Upon accessing, the client terminal device repeatedly transmits a request to the server and receives a response to the request from the server. The request transmitted from the client terminal device to the server is, for example, browsing of products, selecting of a product, checking of a cart, inputting of a product delivery address and a credit card number. The client terminal device receives and displays the response to the transmitted request from the server (for example, a text that explains the product, an image or a video of the product). The customer of the terminal device operates the terminal device after checking the displayed product on the screen and thinking for selecting the product. According to the operation, the terminal device transmits again a next request to the server. The client terminal device repeats transmitting a request and receiving a response until completing a purchase of the target product of the customer. Once completing the purchase, the customer operates the terminal device to terminate browsing of the online shopping site.

In a system that receives requests from many and unspecified customers, as in the online shopping site, it is empirically known that the request interarrival time shows an exponential distribution. In addition, it is known that, when the request interarrival time shows an exponential distribution, the arrival rate of the requests (a request arrival number per unit time) shows a Poisson distribution.

PLT1 discloses an example of the load test execution device.

In the load test execution device disclosed in PLT1, an operator of the load test execution device inputs the number of requests to be processed per unit time that a test-target system processes, as a performance target of a load test, in the load test execution device. Upon executing the load test, the load test execution device automatically adjusts various parameters and transmits requests so as to satisfy the performance target input by the operator.

### CITATION LIST

### Patent Literature

[PLT 1] Japanese Patent Application Laid-Open No. 2006-31178

### SUMMARY OF INVENTION

### Technical Problems

The result of a load test that does not accurately reproduce a load in actual operation is unreliable. As such, a load test execution device is required to accurately reproduce a load in actual operation of a test-target system.

Here, the load test execution device needs to transmit requests that satisfy at least the following two requirements to accurately reproduce a load in actual operation of a test-target system.

(i) The average number of requests that are transmitted per unit time is a desired value.

(ii) Intertransmission time of requests shows a predetermined distribution.

Whether or not the requests that the load test execution device transmits satisfy the requirement (ii) is important for reliability of the load test result.

This is from the following reason.

A test-target system, of which request processing performance does not vary (equal over time), is assumed. Then, the load test execution device transmits requests to the test-target system in a manner in which the average number of requests transmitted per unit time becomes equal. However, it is supposed that the load test execution device transmits requests sometimes at certain interval time and sometimes at random. As such, time required for the load test execution device from transmitting a request until receiving a response (response time) is different in each case. This is because that the distribution of the interval time of the transmitted requests influences the load on the test-target system.

In general, the response time is longer when the request intertransmission time is not equal, compared with when the request intertransmission time is equal.

This is from the following reason.

When requests are transmitted at random interval time, short interarrival time may be continued. When short interarrival time is continued, many requests arrive at the test-target system. As the result, the test-target system cannot complete a process for an already received request before receiving a next request. Generation of an unprocessed request causes a queue.

Therefore, in order not to underestimate response time to requests, the load test execution device needs to transmit requests to the test-target system at interval time according to a predetermined distribution, instead of equal interval time.

However, the load test execution device has a limited number of communication channels (for example, TCP (Transmission Control Protocol) ports) for transmitting requests to the test-target system.

As such, the load test execution device described in PLT1 has a problem that, when transmitting requests so as to accurately reproduce a load in actual operation of the test-target system, the load test execution device cannot apply an appropriate load thereon due to the constraint of available communication channels (TCP ports).

An objective of the present invention is to resolve the above-described problem and provide an information processing device and a load test execution method that can apply an appropriate load on a test-target system.

### Solution to Problem

An information processing device of the first present invention for achieving the above-mentioned problem includes: test storage means for storing a test scenario that includes processing from transmitting a request until receiving a response to the request for a plurality of times and in which time between the reception and the transmission is waiting time during which a TCP connection is disconnected or thinking time during which the TCP connection is preserved; generation means for generating load generation means that applies a load on a system as a subject of applying the load by executing the test scenario; parameter storage means for storing a parameter that defines length of the waiting time; parameter adjustment means for adjusting the parameter so that a desired number of requests arrive at the system per unit time; and communication control means for preserving the TCP connection during the thinking time included in the test scenario that the load generation means is executing and disconnecting the TCP connection during the waiting time.

A control method of a test load device of the second present invention for achieving the above-mentioned problem includes: storing a test scenario that includes processing from transmitting a request until receiving a response to the request for a plurality of times and in which time between the reception and the transmission is waiting time, during which a TCP connection is disconnected, or thinking time, during which the TCP connection is preserved; generating load generation means that applies a load, by executing the test scenario, on a system as a subject of applying the load, and applying the load on the system as the subject of applying the load; storing a parameter that defines length of the waiting time; adjusting the parameter so that a desired number of requests arrive at the system per unit time; and preserving the TCP connection during thinking time included in the test scenario that the load generation means is executing, and disconnecting the TCP connection during waiting time.

A program of the third present invention for achieving the above-mentioned problem causes a computer to execute: test storage processing that stores a test scenario that includes processing from transmitting a request until receiving a response to the request for a plurality of times and in which time between the reception and the transmission is waiting time during which a TCP connection is disconnected or thinking time during which the TCP connection is preserved; generation processing that generates load generation means that applies a load, by executing the test scenario, on a system as a subject of applying the load, and applies the load on the system as the subject of applying the load; parameter storage processing that stores a parameter that defines length of the waiting time; parameter adjustment processing that adjusts the parameter so that a desired number of requests arrive at the system per unit time; and communication control processing that preserves the TCP connection during thinking time included in the test scenario that the load generation means is executing and disconnects the TCP connection during waiting time included therein.

### Advantageous Effects of Invention

According to the present invention, there can be provided an information processing device and a load test execution method that can apply an appropriate load without being much affected by a constraint due to the number of available TCP ports when transmitting requests as the load in actual operation of a test-target system.

### BRIEF DESCRIPTION OF DRAWINGS

FIG. 1 is a block diagram depicting an example of a network configuration of a system that includes a load test execution device according to a first exemplary embodiment of the present invention.

FIG. 2 is a diagram for illustrating behavior of a virtual user.

FIG. 3 is a diagram for illustrating an example of a probability density function of an exponential distribution.

FIG. 4 is a flowchart depicting an example of operation that the load test execution device determines initial values of parameters.

FIG. 5 is a flowchart depicting an example of operation in which the load test execution device adjusts parameters while the load test execution device is executing a load test.

FIG. 6 is a block diagram depicting an example of a network configuration that includes a load test execution device according to a second exemplary embodiment.

FIG. 7 is a flowchart depicting an example of operation that the load test execution device according to the second exemplary embodiment adjusts a parameter while the load test execution device is executing a load test.

FIG. 8 is a block diagram depicting an example of a network configuration that includes a load test execution device according to a third exemplary embodiment;

FIG. 9 is a flowchart depicting an example of operation of the load test execution device according to the third exemplary embodiment.

FIG. 10 is a block diagram depicting an example of a configuration of a load test execution device according to a fourth exemplary embodiment.

### DESCRIPTION OF EMBODIMENTS

The following will describe the exemplary embodiments of the present invention with reference to the drawings.

In addition, the drawings are provided for illustrating the exemplary embodiments of the present invention. Thus, the present invention is not restricted to the description of the drawings. Further, similar components throughout the drawings may be appended the same numerals and are omitted the repeated description of such components.

A load test execution device is used in the description as exemplary embodiments of the information processing devices of the present invention. However, the information processing device of the exemplary embodiments is not restricted to the load test execution device.

Further, TCP/IP (Transmission Control Protocol/Internet Protocol) is used in the description as an example of a channel that the information processing device of the present invention uses. However, the channel that the information processing device of the exemplary embodiments uses is not restricted to TCP. For example, the information processing device of the exemplary embodiments may use Internet Protocol (IP) or User Datagram Protocol (UDP), or may use a Fiber Channel.

### First Exemplary Embodiment

A load test execution device 10 according to a first exemplary embodiment of the present invention will be described in detail with reference to the drawings.

<Description of Configuration>

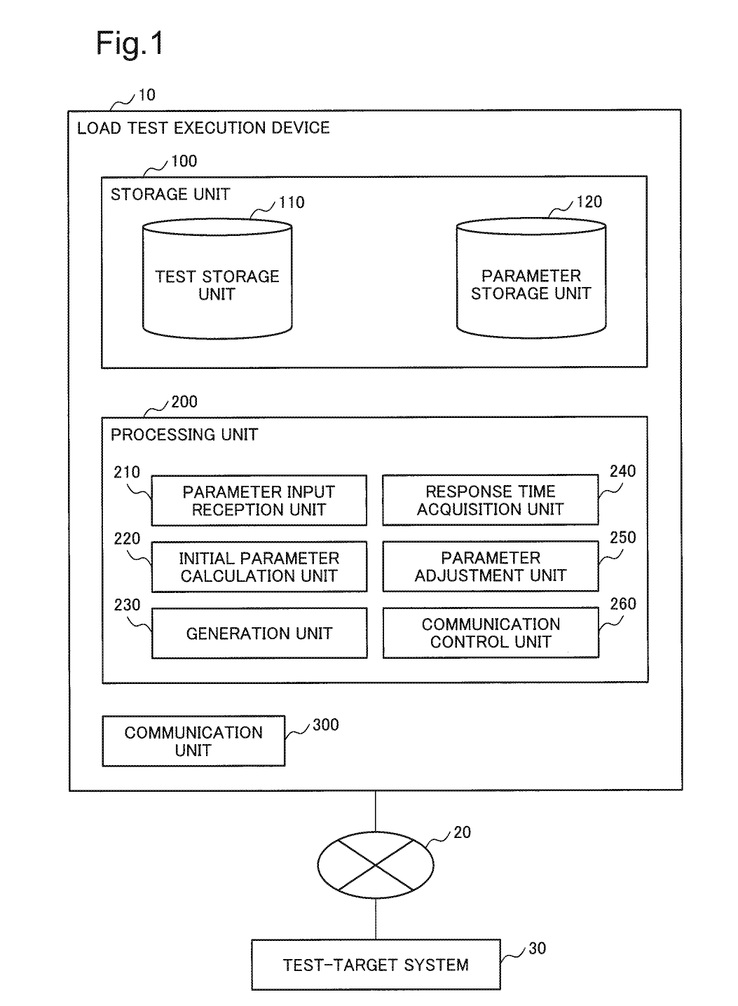

FIG. 1 is a block diagram depicting an example of a network configuration of a system that includes the load test execution device 10 according to the first exemplary embodiment of the present invention.

The load test execution device 10 of the first exemplary embodiment communicates with a test-target system 30 via a network 20. Then, the load test execution device 10 executes a load test on the test-target system 30.

The “load test” is a test that verifies accuracy of the performance and behavior of the test-target system 30 when a load is applied on the test-target system 30 over a predetermined term.

The load test execution device 10 establishes a channel (a TCP connection) with the test-target system 30, transmits requests to the test-target system 30, and applies a predetermined load. The load test execution device 10 will be described again later herein.

The test-target system 30 is a system that is the subject of the load test of the load test execution device 10 and is, for example, a server or an information processing system. The test-target system 30 processes the request received from the load test execution device 10 and responds to the load test execution device 10.

The intertransmission time and average transmission number per unit time (request transmission rate) of the requests that the load test execution device 10 transmits are, from the perspective of the test-target system 30, the interarrival time and average arrival number per unit time (request arrival rate) of the requests.

Therefore, hereinafter, the request intertransmission time and interarrival time is collectively referred to as the “request interval time”. Further, the request transmission rate and request arrival rate are collectively referred to as the “request rate”. In addition, it is noted that the value of the request rate (the request transmission rate and request arrival rate) is equal to the value of throughput that represents the number of requests that are processed per unit time.

The network 20 is a communication channel that connects the load test execution device 10 and the test-target system 30. The load test execution device 10 secures a channel (TCP) in the network 20 for adding a load on the test-target system 30.

Next, the following will describe the configuration of the load test execution device 10 of the first exemplary embodiment.

The load test execution device 10 includes a storage unit 100, a processing unit 200, and a communication unit 300. The load test execution device 10 may be configured using a computer that realizes the functions of such components.

The storage unit 100 includes a test storage unit 110 and a parameter storage unit 120.

The test storage unit 110 stores a test scenario.

Here, the “test scenario” is a scenario according to which the load test execution device 10 transmits requests to, in other words, applies a load on the test-target system 30. There is no particular restriction in the test scenario of the first exemplary embodiment. For example, the test scenario may be a script for transmitting requests. Then, the test scenario includes once or a plurality of times of processing from transmitting a request until receiving a response to the request. The specific content of the test scenario is stored in advance in the test storage unit 110. For example, in consideration of a typical processing content of the test-target system 30, an operator of the load test execution device 10 determines a test scenario and stores the test scenario in the test storage unit 110.

The parameter storage unit 120 stores parameters that are needed when the load test execution device 10 executes a load test. There is no particular restriction in the parameters that the parameter storage unit 120 stores. For example, these parameters are “the number of virtual users”, “thinking time”, “waiting time”, and “assumed response time”. The following will describe the first exemplary embodiment using these parameters. To that end, the definition of these parameters will be described.

The first parameter “the number of virtual users” is a parameter that indicates how many test scenarios of virtual users are executed in parallel by the load test execution device 10 in a load test.

Here, the “virtual user” is a function for transmitting requests to a test-target system 30. The virtual user is generated using the generation unit 230 which will be described below.

The load test execution device 10 according to the first exemplary embodiment is a device that simulates access to the test-target system 30 using a plurality of virtual users. In other words, the number of virtual users means the number of users that are virtually simulated by the load test execution device 10 (more specifically, for example, the number of terminal devices that access the test-target system 30).

There is no particular restriction in the method in which the load test execution device 10 simulates the parallel operation of a plurality of virtual users. The simulation method may be, for example, a method that generates threads or processes at OS (Operating System) level for the number of virtual users and executes a test scenario in each thread or process.

In addition, the “virtual user” corresponds to the “load generation means” as described in the claims.

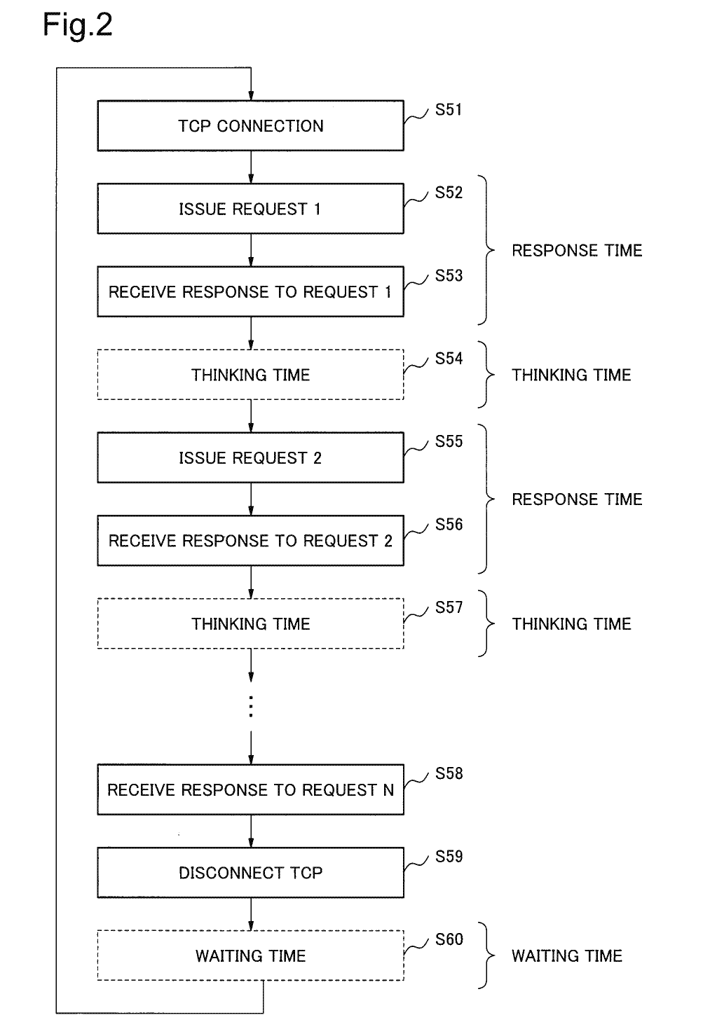

FIG. 2 is a diagram for illustrating behavior of a virtual user of the load test execution device 10 of the first exemplary embodiment.

The virtual user first establishes a channel (a TCP connection) according to a channel (for example, the TCP protocol) before transmitting a request to the test-target system 30 (S51). Based on the established channel, a theoretical channel (a TCP connection) for exchanging requests and responses is prepared between the load test execution device 10 in which virtual users operate and the test-target system 30.

After the establishment of the TCP connection, a virtual user transmits requests as defined in the test scenario.

First, the virtual user transmits a first request (S52), and receives a response to the first request (S53).

Next, the virtual user transmits a second request (S55), and receives a response to the second request (S56).

The virtual user repeats this operation. Then, when the virtual user receives a response to the Nth request of a certain number of requests (N) that is defined in the test scenario (S58), the virtual user disconnects the TCP connection (S59).

In addition, the virtual user may transmit a next request without waiting the response to a request. In such a case, the virtual user disconnects the TCP connection after receiving all responses from the first request to the Nth requests. However, in the following description, the virtual user transmits a next request after waiting the response to the request, for convenience of explanation.

The virtual user completes processing for one user from establishing a TCP connection (S51) until disconnecting the TCP connection (S59).

Then, after pausing for predetermined time after receiving the response to the Nth request (S60), the virtual user executes the test scenario again.

The virtual user repeats execution of the test scenario for certain times or during a certain time period.

The virtual user repeats execution of a test scenario so that the virtual user can keep applying a load over a predetermined term on the test-target system 30.

In addition, such a mechanism where a certain number of virtual users repeat similar request processing is referred to as a “closed model”.

Time from when a virtual user transmits a request until when a virtual user receives a response to the request is referred to as “response time”.

The response time is extended or shortened in accordance with the processing content of a request and a load of a device, such as, a server, a network, and a disk. As such, the response time is time that is uncontrollable from the load test execution device 10.

In a closed model, there is a problem that, when a load on a test-target system 30 increases and response time is extended, time when a virtual user transmits the next request is delayed. In other words, the closed model has a problem that, as a load on the test-target system 30 becomes higher, a load that a virtual user generates (the number of requests transmitted per unit time) decreases.

The second parameter “thinking time” is a parameter that defines interval time from when a virtual user receives the response to a given request until when the virtual user transmits the next request (S54, S57). The TCP connection is preserved during the thinking time.

As will be described later, the load test execution device 10 determines thinking time using random number. The average value of thinking time can be set as a parameter by the operator of the load test execution device 10.

The third parameter “waiting time” is a parameter that defines interval time from when a virtual user receives the response to the last request of a test scenario and disconnects a TCP connection until when the virtual user executes the test scenario again, establishes a TCP connection, and transmits the first request (S60). Alternatively, the “waiting time” is a parameter that defines interval time from when a virtual user disconnects a TCP connection until when the virtual user executes the test scenario again and starts establishing a TCP connection. During the waiting time, the TCP connection is disconnected.

The thinking time and waiting time are different in terms of the existence of a TCP connection.

The load test execution device disclosed in above-described PLT1 and the load test tool relevant to the present invention do not distinguish the thinking time and the waiting time.

Whereas, the load test execution device 10 according to the first exemplary embodiment uses the thinking time and the waiting time to execute a load test that is not much affected by the constraint of the number of TCP ports.

In the same way as thinking time, the load test execution device 10 determines waiting time using random number. The average value of waiting time can be set as a parameter by the operator of the load test execution device 10. The details of the waiting time will be described later herein.

The parameter that defines the length of “waiting time” corresponds to the “parameter” described in the claims.

The fourth parameter “assumed response time” is set to the value of “assumed minimum response time (RT_{MIN})” as an initial value. Thereafter, the “assumed response time” is a parameter that is updated to the value of “average response time (RT_{AVE})” that the response time acquisition unit 240 acquires.

The definition of the “average response time (RT_{AVE})” will be described later.

Now, the description goes back to FIG. 1.

The processing unit 200 includes: a parameter input reception unit 210; an initial parameter calculation unit 220; a generation unit 230; a response time acquisition unit 240; a parameter adjustment unit 250; and a communication control unit 260.

The parameter input reception unit 210 accepts parameters in order to calculate the initial parameters for executing a load test. The parameter input reception unit 210 may include, for example, an input device which is depicted and accept parameters from input operation by an operator. Alternatively, the parameter input reception unit 210 may receive parameters from an external device which is not depicted and is operated by an operator. Hereinafter, this operation is collectively described as “the parameter input reception unit 210 accepts parameters from an operator” or “an operator inputs parameters”.

The initial parameter calculation unit 220 calculates initial parameters for executing a load test based to the parameters that the parameter input reception unit 210 accepted.

The generation unit 230 generates virtual users and causes the virtual users to execute a test scenario. As described above, the virtual user transmits requests to the test-target system 30 to apply a load thereon.

Further, as described above, there is no particular restriction in the method in which the generation unit 230 has a plurality of virtual users operate in parallel. For example, the method used by the generation unit 230 includes a method that generates threads or processes on the OS level for the number of virtual users, and causes the threads or the processes to execute test scenarios.

The response time acquisition unit 240 acquires average response time (RT_{AVE}) that is the average value of response time for all the requests that the load test execution device 10 transmitted during a predetermined term. As described above, the response time is an observed value that is uncontrollable by the operator. Thus, the average response time (RT_{AVE}) is a value that is uncontrollable by the operator. When acquiring the average response time (RT_{AVE}), the response time acquisition unit 240 updates the value of the “assumed response time” stored in the parameter storage unit 120.

The parameter adjustment unit 250 calculates new waiting time based on the average response time (RT_{AVE}) that the response time acquisition unit 240 acquired. The details of the operation of the parameter adjustment unit 250 will be described later herein.

The communication control unit 260 controls the communication unit 300 so as to preserve a TCP connection while a virtual user is executing a test scenario, in other words, during the response time and the thinking time. Further, the communication control unit 260 controls the communication unit 300 so as to disconnect a TCP connection during time from when the virtual user disconnects TCP until when the virtual user reconnects TCP, in other words, during the waiting time.

According to the control of the communication control unit 260, the communication unit 300 establishes or disconnects a TCP connection between the load test execution device 10 and the test-target system 30 according to the TCP/IP protocol. The number of TCP ports that the load test execution device 10 can use is 65,536 at the maximum due to the constraint of the TCP/IP protocol. Further, part of the TCP ports is reserved for specific purposes. As such, the number of the TCP ports that are available for the load test execution device 10 is smaller than the maximum value. In this way, the number of the TCP ports that the load test execution device 10 can use is limited.

<Hardware Configuration>

The storage unit 100 of the load test execution device 10 can be realized by using a RAM (Random Access Memory) or a HDD (Hard Disk Drive).

Each means included in the processing unit 200 of the load test execution device 10 can be realized based on the execution of a predetermined program or code by the CPU (Central Processing Unit) included in the load test execution device 10.

The communication unit 300 of the load test execution device 10 can be realized, for example, by controlling the network interface card (NIC) by an application program executed by the CPU using the function provided by the OS that the CPU of the load test execution device 10 executes.

<Description of Operation>

Next, the following will describe operation of the load test execution device 10 according to the first exemplary embodiment.

Hereinafter, first, each of the thinking time and the waiting time will describe in details.

Next, the outlines of the load test that the load test execution device 10 executes will be described; then the details of the relationship among the parameters will be described.

Subsequently, each of the operation in which the load test execution device 10 determines the initial values of the parameters and the operation in which the load test execution device 10 adjusts the parameters while executing the load test will be described in details.

First, the details of the thinking time will be described.

As described above, the thinking time is interval time from when a virtual user receives the response to a request until when the virtual user transmits the next request.

The thinking time is time that simulates “time that is taken for a user (a terminal device) to select a request”.

For example, a case in which the test-target system 30 is an online shopping site is supposed.

For example, a customer of the online shopping site may receive a response to a request (for example, a text that describes a product, an image or video of the product) from a server, check the displayed product on a screen, think for selecting a product, and input a product delivery address or a credit card number by operating a terminal device. After receiving the response to the request and all the time has passed, the customer transmits the next request to the server by operating the terminal device.

The thinking time is preferably a value determined by random number according to a probability distribution such as an exponential distribution or a Pareto distribution. This is because the load test execution device 10 simulates a phenomenon in which the request interarrival time shows an exponential distribution during actual operation of the test-target system 30. The request interarrival time is expressed by the sum of the response time and the thinking time. However, the response time is uncontrollable by the operator of the load test execution device 10. Thus, the generation unit 230 determines the thinking time using random number. In addition, the parameter storage unit 120 stores the average value of the thinking time.

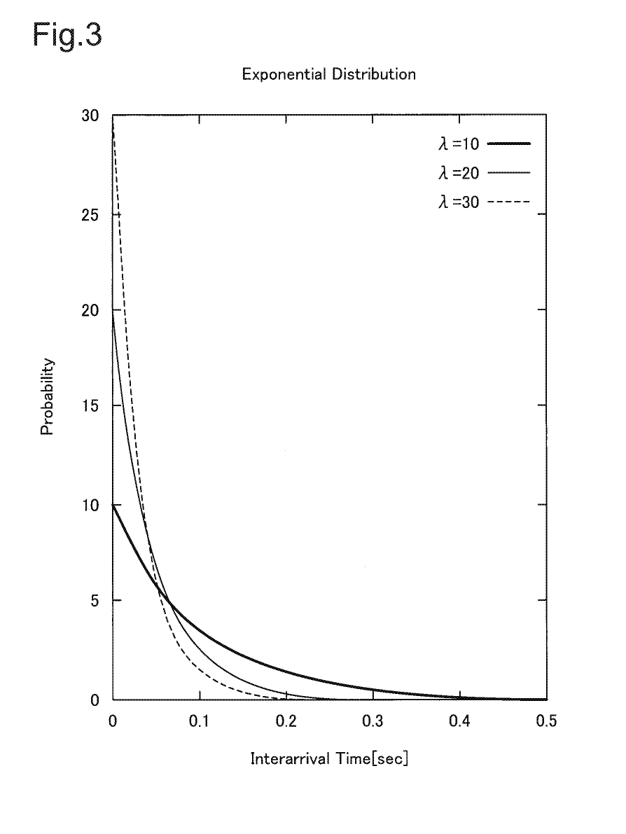

FIG. 3 is a diagram for illustrating an example of a probability density function of an exponential distribution.

In FIG. 3, the horizontal axis indicates request interarrival time and the vertical axis indicates probability.

The exponential distribution is a probability distribution that has a parameter (λ). The expectation (average value) of the request interarrival time becomes “1/λ”. When the request interarrival time is “1/λ”, the reciprocal (λ) indicates the number requests that arrive per second (request arrival rate). For example, when the average request interarrival time is 1/20 (=0.05) seconds, the average request arrival rate is 20 [requests/second].

When the interarrival time is not equal (constant) and show a probability distribution as depicted in FIG. 3, long and short interarrival time is mixed. Then, when the interarrival time is short, many requests arrive at the server. As such, a queue is generated, and the average response time (RT_{AVE}) is possibly extended. In general, even if the average interarrival time is the same, when the interarrival time varies as depicted in FIG. 3, the average response time (RT_{AVE}) becomes longer than when the interarrival time is equal. In order not to underestimate the average response time (RT_{AVE}), it is important that the load test execution device 10 preserves variation of the request interarrival time (hereinafter, referred to as “load variation”) when executing a load test.

Next, the details of the waiting time will be described.

As described above, the waiting time is interval time from when a virtual user receives the response to the last request of a test scenario and disconnects a TCP connection until when the virtual user executes the test scenario again, establishes a TCP connection, and transmits the first request.

In the closed model as a presumption of the present invention, for convenience, one virtual user simulates behavior of a plurality of users by repeating execution of a test scenario.

The waiting time is time that simulates “time from when processing of a request from a certain user ends until when a request from another user arrives”. In a broad way, the waiting time corresponds to the ratio that users visit the Web site of an online shopping site (that can be called a user arrival rate), instead of the request arrival rate. In the same way as the thinking time, the generation unit 230 determines the waiting time using random number. The parameter storage unit 120 stores the average value of the waiting time.

<Description of Relationship Among Parameters>

Next, the following will describe the details of the relationship among parameters when the load test execution device 10 executes a load test.

It is supposed that the number of virtual users is “W”, the waiting time is “ST”, the assumed response time is “RT”, the thinking time is “TT”, the number of requests included in one test scenario is “N”, and overhead that is taken in relation to a TCP connection and others is “α”.

Time required for one virtual user to complete processing for a portion of one user is expressed by the following [Formula 1] (refer to FIG. 2).

Time required for completion=ST+N×RT+(N−1)×TT+α [Formula 1]

The reason why the coefficient of the thinking time (TT) becomes “(N−1)” in [Formula 1] is because, as can be seen from FIG. 2, the number of the intervals of requests becomes “(N−1)” for the number of requests (N).

The number of times that a virtual user executes a test scenario per unit time (for example, per second) becomes a reciprocal of [Formula 1]. The number of requests that a virtual user transmits per unit time can be obtained by multiplying the reciprocal of [Formula 1] by the number of requests (N) included in one test scenario.

Here, when there are “W” units of such virtual users, the number of requests (M) that the load test execution device 10 transmits per unit time to the test-target system 30 is calculated using the following [Formula 2].

M=W×N/(ST+N×RT+(N−1)×TT+α) [Formula 2]

Here, to simplify the description, the distinction between the thinking time (TT) and the waiting time (ST) is removed to make “ST=TT”. Then, [Formula 2] can be simplified as [Formula 3]. In addition, the overhead “α” can be ignored as “α” is sufficiently small compared with other parameters.

M=W/(RT+TT) [Formula 3]

The parameters of the right side of [Formula 3] will be thoroughly examined.

The thinking time (TT) and the number of virtual users (W) are parameters that are controllable by the operator of the load test execution device 10. The response time is an observed value that is uncontrollable by the operator. There are numerous combinations of the number of virtual users (W) and the thinking time (TT) that realize a certain request arrival rate (M).

As can be seen from [Formula 3], to increase the request arrival rate (M), it is necessary to increase the number of virtual users (W) or decrease the thinking time (TT).

However, short thinking time (TT) causes the following inconvenience.

For example, it is supposed that the number of virtual users is “1” (W=1) and the request arrival rate is desirably set as “100” (M=100). Here, the load test execution device 10 needs to set the thinking time (TT) to a value close to 0.01. To this end, the thinking time (TT) is determined by, for example, random number according to an exponential distribution with the expectation of 0.01.

However, it is supposed that the average response time (RT_{AVE}) is one second as the result of the load test.

Then, the request intertransmission time becomes 1.01 seconds (request arrival rate (M) is less than 1).

As the result, the request arrival rate becomes largely below the desired request arrival rate of “100”. Furthermore, the effect of “load variation” that is reproduced using random number for the thinking time (TT) is almost lost.

As such, to reproduce “load variation”, the thinking time (TT) needs to have a certain degree of length compared with the assumed response time (RT).

Furthermore, excessively short thinking time (TT) causes the following problem, in addition to impossibility of reproducing “load variation”.

The OS of the load test execution device 10 needs to manage timing of pausing a plurality of virtual users.

In general, switching of the states of the processes and threads of an OS is performed based on a time unit called tick. With a general OS, a tick is approximately 10 milliseconds to 100 micro milliseconds.

With the OS that has a tick of 10 milliseconds, even when pausing of 1 millisecond is desired, the actual pausing time becomes at least 10 milliseconds. As the result, thinking time (TT) that is set as a parameter and the actual thinking time do not match. While it may depend on the distribution of thinking time (TT) to be assumed, the expectation of the thinking time (TT) may preferably be ten times as much as the value of the tick.

When the thinking time (TT) is large, the number of virtual users (W) needs to be a large value ([Formula 3]) in order to preserve a certain request arrival rate (M).

As such, in order to apply a desirable load on the test-target system 30 while preserving load variation, the number of virtual users (W) and the thinking time (TT) are both preferably large values to some extent. If both the number of virtual users (W) and the thinking time (TT) are large, many tasks or threads keep preserving TCP connections.

However, as described above, the number of TCP ports that the load test execution device 10 can use is restricted by the TCP/IP protocol. For this reason, even if both the number of virtual users (W) and thinking time (TT) are attempted to be set to large values, the load test execution device 10 is restricted by the number of TCP ports.

The load test execution device disclosed in above-described PLT1 and the load test tool relevant to the present invention do not distinguish the thinking time and the waiting time.

Whereas, the load test execution device 10 according to the first exemplary embodiment focuses on a difference between the thinking time that is time during which a TCP connection is preserved and the waiting time that is time during which a TCP connection is disconnected.

When transmitting requests of the same unit amount per unit time while preserving the above-described load variation, the load test execution device 10 shortens the thinking time to the extent where the effect of the load variation does not disappear, and lengthens the waiting time. As such, the TCP connection time is shorten. In this way, the load test execution device 10 can save the number of TCP ports necessary for preserving connections.

Further, the load test execution device 10 determines the waiting time by random number. As such, the load test execution device 10 can reproduce variation in intervals of time when virtual users arrive. As the result, the load test execution device 10 can reproduce load variation more accurately than the load test device described in PLT1.

Next, the operation in which the load test execution device 10 according to the first exemplary embodiment determines the initial values of parameters will be described in detail.

<Description of Operation of Determining Initial Values of Parameters>

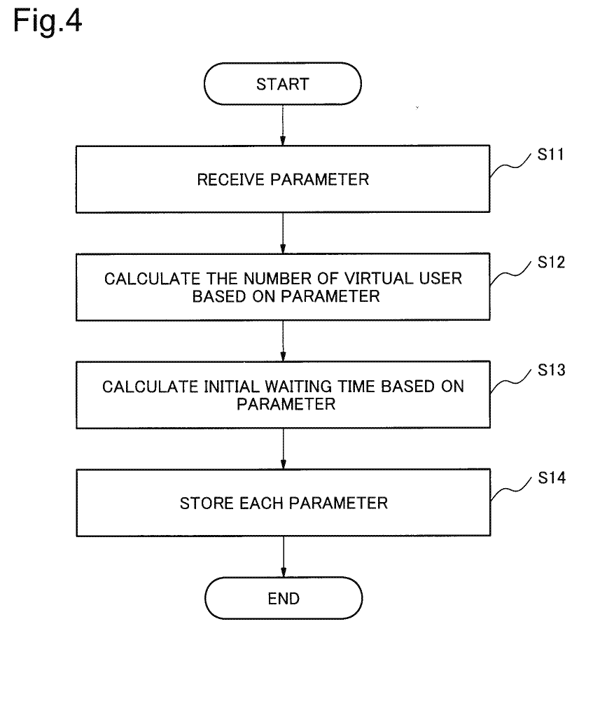

FIG. 4 is a flowchart diagram depicting an example of operation in which the load test execution device 10 determines the initial values of parameters.

The parameter input reception unit 210 accepts parameters from an operator. There is no particular restriction in the parameters. As an example, hereinafter, the accepting parameters are “assumed throughput (M)”, “minimum thinking time (TT_{MIN})”, “minimum waiting time (ST_{MIN})”, “assumed maximum response time (RT_{MAX})”, “assumed minimum response time (RT_{MIN})” and “the number of requests included in the test scenario (N)” (S11).

Next, the initial parameter calculation unit 220 calculates the “the number of virtual users (W)” and “initial waiting time (TT_{INI})” based on the parameters that the parameter input reception unit 210 accepted (S12, S13).

The parameter input reception unit 210 and the initial parameter calculation unit 220 store the above-described parameters in the parameter storage unit 120 (S14).

The following will describe each operation in detail.

First, the details of parameters that the parameter input reception unit 210 accepts from the operator at “S11” will be described.

The “assumed throughput (M)” is a parameter that indicates a desired load that the operator of the load test execution device 10 wants to apply on the test-target system 30. The assumed throughput (M) is indicated by the number of requests per unit time (for example, 100 [requests/second]).

The “minimum thinking time (TT_{MIN})” is a parameter that indicates the minimum thinking time permitted by an operator. As described above, the thinking time (TT) is preferably set to a certain degree of length with reference to the response time in order to preserve load variation. Therefore, the operator sets a value that has a certain degree of amount with reference to the assumed response time (RT) as the minimum thinking time (TT_{MIN}).

In the load test execution device 10 according to the first exemplary embodiment, the value of the thinking time (TT) stored in the parameter storage unit 120 is set to the value of the minimum thinking time (TT_{MIN}) without being changed.

The “minimum waiting time (ST_{MIN})” is the shortest waiting time (ST) that is permitted by an operator. For the same reason as the thinking time (TT), the value of the waiting time (ST) is preferably a value that has a certain degree of amount with reference to the response time in order to preserve load variation. Therefore, the operator sets a value that has a certain degree of amount with reference to the assumed response time (RT) as the minimum waiting time (ST_{MIN}).

The “assumed maximum response time (RT_{MAX})” and the “assumed minimum response time (RT_{MIN})” are parameters that indicate, respectively, the permissible maximum value of the average response time (RT_{AVE}) that the operator estimated in advance with regard to the response performance of the test-target system 30 and the minimum value of observable assumed response time (RT).

For example, with the assumed throughput of 100 [requests/second], in order to make the average response time (RT_{AVE}) of a test-target system 30 4 seconds or shorter, the operator sets the assumed maximum response time (RT_{MAX}) to “4 seconds”. The assumed minimum response time (RT_{MIN}) can be set to “0 second” when there is no value that can be assumed beforehand.

“The number of requests included in a test scenario (N)” is the number of requests included in one test scenario. “The number of requests included in a test scenario (N)” may be a parameter that the parameter input reception unit 210 accepts from an operator. Alternatively, “the number of requests included in a test scenario (N)” may be defined in advance in a test scenario.

Next, the operation at S12 in which the initial parameter calculation unit 220 calculates “the number of virtual users (W)” will be described in detail.

“The number of virtual users (W)” is calculated using [Formula 4] that is modified from [Formula 2]. However, the overhead “α” is ignored as being sufficiently small compared with other parameters.

W=M×{ST+N×RT+(N−1)×TT}/N [Formula 4]

For example, it is supposed that the parameters that the parameter input reception unit 210 accepted are “assumed throughput (M)=100”, “assumed maximum response time (RT_{MAX})=4”, “assumed minimum response time (RT_{MIN})=0”, “minimum thinking time (TT_{MIN})=5”, “minimum waiting time (ST_{MIN})=5”, and “the number of requests included in a test scenario (N)=5”.

The initial parameter calculation unit 220 uses the assumed maximum response time (RT_{MAX}) as response time when calculating “the number of virtual users (W)”. In the above example, the number of virtual users (W) is calculated as “W=100×{5+5×4+(5−1)×5}/5=900”. Thus, for example, if “900 units” of virtual users are prepared, even when the average response time (RT_{AVE}) is extended to the assumed maximum value of “4 seconds”, the load test execution device 10 can transmit desired requests (M) while preserving the minimum waiting time (ST_{MIN}) and thinking time (TT_{MIN}).

The load test execution device 10 according to the first exemplary embodiment does not change the value of the number of virtual users (W) stored in the parameter storage unit 120, once the value is set.

Next, the operation at S13, in which the initial parameter calculation unit 220 calculates “initial waiting time (ST_{INI})”, will be described in detail.

The following [Formula 5] can be obtained by modifying [Formula 2]. However, the overhead “α” is ignored as being sufficiently small compared with other parameters.

ST+N×RT=W×N/M−(N−1)×TT=constant [Formula 5]

As described above, the value of “the number of virtual users (W)” will not be changed once it is calculated. Further, the value of “assumed throughput (M)” and the value of “minimum thinking time (TT_{MIN})” will not be changed from the values determined by the parameter input reception unit 210. Therefore, the right side of the above [Formula 5] becomes constant. In the above-described example, the right side of the above [Formula 5] becomes “W×N/M−(N−1)×TT=25”.

The parameter that is changed during execution of a load test among the load parameters is waiting time (ST).

The initial parameter calculation unit 220 can obtain a desired load (throughput (M)) when executing a load test by adjusting the waiting time (ST) so as to maintain “ST+N×RT=constant (“25” in the case of the above example)”. In the above-described example, the load becomes “M=100 [requests/second]”.

The value of the number of virtual users (W) is calculated using the assumed maximum response time (RT_{MAX}). As such, when the actual average response time (RT_{AVE}) is shorter than the assumed maximum response time (RT_{MAX}), requests more than the necessity are transmitted.

The test-target system 30 may perform unstable operation when a load beyond assumption is applied thereon. In the worst case, the test-target system 30 stops. When stopping, the test-target system 30 needs to be rebooted for continuing the load test. As a result, there happens a problem in which the efficiency in execution of the test decreases.

In order to avoid this problem, when calculating “initial waiting time (ST_{INI})”, the initial parameter calculation unit 220 assumes the assumed response time (RT) as the assumed minimum response time (RT_{MIN}), and, accordingly, sets the initial waiting time (ST_{INI}) longer for that portion.

For example, in this example, the assumed minimum response time (RT_{MIN}) is “0 [second]”. As such, according to [Formula 5], the initial waiting time (ST_{INI}) becomes “25 [seconds]”.

Next, (S14) will be described in detail.

The parameter input reception unit 210 stores the value of “minimum thinking time (TT_{MIN})” as “thinking time (TT)” in the parameter storage unit 120. In the same way, the parameter input reception unit 210 stores the value of “the number of virtual users (W)” in the parameter storage unit 120. The parameter input reception unit 210 stores the value of “initial waiting time (ST_{INI})” as “waiting time (ST)” in the parameter storage unit 120.

And, the parameter input reception unit 210 stores the value of “assumed minimum response time (RT_{MIN})” as the initial value of “assumed response time (RT)” in the parameter storage unit 120.

For example, in the above example, the initial values of “the number of virtual users (W)”, “thinking time (TT)”, “waiting time (ST)”, and “assumed response time (RT)” stored in the parameter storage unit 120 are respectively stored as “900 units”, “5 seconds”, “25 seconds”, and “0 second”.

<Description of Operation that Adjusts Parameter while Executing Load Test>

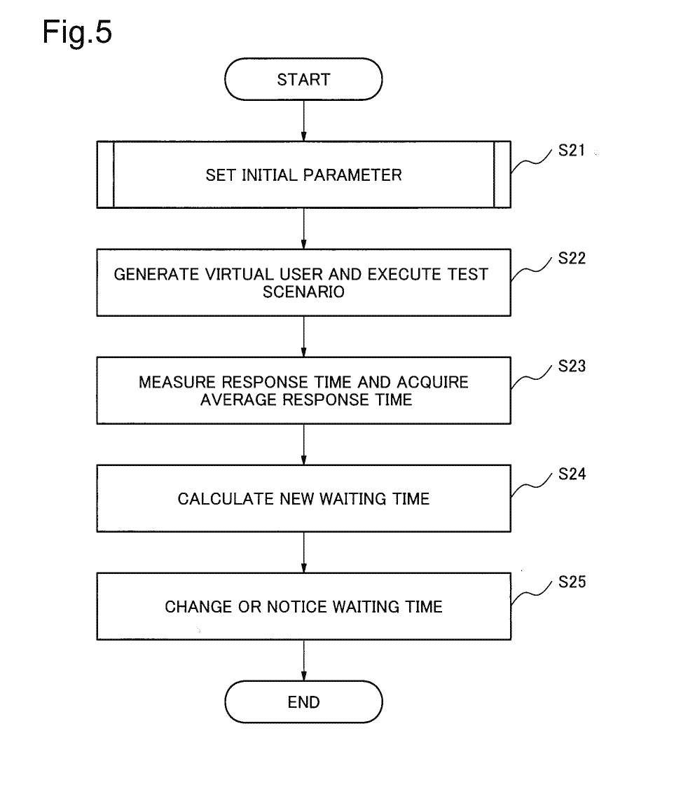

FIG. 5 is a flowchart depicting an example of operation in which the load test execution device 10 adjusts a parameter while executing a load test.

In addition, the parameters used in the description are the same as FIG. 4.

As based on the above-described processing, the parameter storage unit 120 stores necessary parameters in advance (S21).

First, the generation unit 230 generates “W units” of virtual users according to the parameter “the number of virtual users (W)” retained in the parameter storage unit 120 and causes the virtual users to operate in parallel (S22).

The method in which the generation unit 230 causes a plurality of virtual users to operate in parallel includes, as described above, a method of generating threads or processes on the OS level for the number of virtual users and causing the threads or processes to execute test scenarios. The generation unit 230 causes the generated virtual users to execute test scenarios in parallel according to the parameters “thinking time (TT)” and “waiting time (ST)” retained in the parameter storage unit 120.

Next, the response time acquisition unit 240 measures the response of the test-target system 30 in relation to the execution of the test scenario. Then, the response time acquisition unit 240 acquires “average response time (RT_{AVE})” that is the average value of the measured response time (S23).

As described above, the “(average response time RT_{AVE})” is the average value of the response time to all the requests that the load test execution device 10 transmitted during a certain term.

The parameter adjustment unit 250 refers to the “average response time (RT_{AVE})” that the response time acquisition unit 240 acquired and the parameters retained in the parameter storage unit 120 and calculates new “waiting time (ST)” (S24).

The parameter adjustment unit 250 updates the value of “waiting time (ST)” stored in the parameter storage unit 120 with the value of calculated “waiting time (ST)”.

In addition, the parameter adjustment unit 250 may output the calculated “waiting time (ST)” value to an external output device, not depicted, instead of updating the value of “waiting time (ST)” stored in the parameter storage unit 120.

The response time acquisition unit 240 updates the value of the assumed response time RT stored in the parameter storage unit 120 with the acquired “average response time (RT_{AVE})” (S26).

The operation of S24 will be further described in detail.

In order to preserve the amount of requests transmitted by virtual users to a certain value, as has been described with reference to [Formula 5], the load test execution device 10 may maintain the value of “ST+N×RT” to a certain value.

Here, it is supposed that the “average response time (RT_{AVE})” that has been assumed before execution of the test scenario is defined as “RT0” and the “waiting time (ST)” that is calculated based on the “RT0” is defined as “ST0”. Further, it is supposed that the “average response time (RT_{AVE})” that is actually measured in the execution of the test scenario is defined as “RT1”. Then, “waiting time (ST1)” based on these values is calculated using the following [Formula 6] that is obtained by modifying the left side of [Formula 5].

In other words, [Formula 6] that is obtained by modifying “ST0+N×RT0=ST1+N×RT1” is as follows.

ST1=ST0−N×(RT1−RT0) [Formula 6]

“RT0” that is the “average response time (RT_{AVE})” assumed before execution of the test scenario is “RT0=assumed minimum response time (RT_{MIN})=0 second”. “ST0” that is the “waiting time (ST)” calculated based on “RT0” is “ST0=initial waiting time (ST_{INI})”.

Here, it is supposed that the “average response time (RT_{AVE})” that the response time acquisition unit 240 acquired is “1 second”. Then, the actual request arrival rate becomes “900×5/(25+5×1+(5−1)×5)=90 [requests/second]” from [Formula 5], and does not reach desired 100 [requests/second]. Thus, the parameter adjustment unit 250, based on the “average response time (RT_{AVE})” that the response time acquisition unit 240 acquired, updates the “waiting time (ST1)” to “25−5×(1−0)=20 seconds” using [Formula 6]. As such, to achieve the desired “100 [requests/second]” when the “average response time (RT_{AVE})” is 1 second, the load test execution device 10 needs to shorten the “waiting time (ST)” from 25 seconds to 20 seconds.

In short, the parameter adjustment unit 250 substitutes the “assumed response time (RT)” that is stored in the parameter storage unit 120 for “RT0”, the “waiting time (ST)” stored in the parameter storage unit 120 for “ST0”, and the actual “average response time (RT_{AVE})” measured at S24 for “RT1” in [Formula 6], and calculates new “waiting time (ST1)”.

As the result of shortening the “waiting time (ST)”, a higher load will be applied on the test-target system 30 when next time a virtual user executes the test scenario. As such, the “average response time (RT_{AVE})” may possibly be further extended from 1 second. In such a case, the load test execution device 10 resets the “waiting time (ST)” and repeats the test. According to this operation, the load test execution device 10 can finally achieve a desired request arrival rate.

In the load test execution device relevant to the present invention that does not distinguish “thinking time (TT)” and “waiting time (ST)”, both “the number of virtual users (W)” and “thinking time (TT)” are required to be set to sufficiently large values for reproducing load variation. As such, the load test execution device relevant to the present invention needs to preserve TCP connections for many threads.

The load test execution device 10 according to the first exemplary embodiment, can generate a desired load by adjusting the “waiting time (ST)”, during which a TCP connection is disconnected, while maintaining the “thinking time (TT)” that is time when a TCP connection is preserved to the minimum requirement value (minimum thinking time (TT_{MIN})) for reproducing load variation. Based on this operation, the load test execution device 10 can decrease the TCP connection time during which virtual users execute test scenarios, and save the TCP ports and other resources to be consumed for connection.

Further, the load test execution device 10 according to the first exemplary embodiment stores parameters (for example, “the number of virtual users (W)”, “thinking time (TT)”, “waiting time (ST)”) in the parameter storage unit 120 based on the parameters input by the operator.

The parameters input by the operator of the load test execution device 10 of the first exemplary embodiment are parameters that all are intuitionally easily understood. As such, with the load test execution device 10, even an operator without many experiences or expertise with regard to the load test can also easily execute an appropriate load test.

Further, in the load test execution device 10 according to the first exemplary embodiment, “the number of virtual users (W)” is calculated on the basis of the “assumed maximum response time (RT_{MAX})”, “minimum thinking time (TT_{MIN})”, and “minimum waiting time (ST_{MIN})” using [Formula 4]. Therefore, even if the “average response time (RT_{AVE})” is extended to the “assumed maximum response time (RT_{MAX})”, the load test execution device 10 can transmit desired “requests (M)” while maintaining minimum “thinking time (TT_{MIN})” and “waiting time (ST_{MIN})” for preserving load variation.

Further, in the load test execution device 10 according to the first exemplary embodiment, the parameter adjustment unit 250 adjusts the “waiting time (ST)” for transmitting desired “requests (M)” without changing the “the number of virtual users (W)” from the initial value. As such, the load test execution device 10 can be prevented from excessively setting “the number of virtual users (W)”.

If “the number of virtual users (W)”, in other words, the number of processes or threads is excessively set, for example, the overhead “a” required for switching virtual users becomes large. As a result, there happens a problem in which efficiency of executing a test scenario decreases.

However, the load test execution device 10 according to the first exemplary embodiment does not cause such a problem.

Further, in the load test execution device 10 according to the first exemplary embodiment, the “initial waiting time (ST_{INI})” is calculated based on the “assumed minimum response time (RT_{MIN})”. Thus, even if “average response time (RT_{AVE})” is close to the assumed minimum value, “initial waiting time (ST_{INI})” is set sufficiently long. As such, the load test execution device 10 can be prevented from applying a load that is higher than assumption on the test-target system 30.

### Variations of First Exemplary Embodiment

The following will describe regarding various variations of the load test execution device 10 according to the first exemplary embodiment as described above.

The parameter adjustment unit 250 may calculate “waiting time (ST)” using [Formula 2] or [Formula 4] without using [Formula 6].

In such a case, the parameter storage unit 120 retains “assumed throughput” instead of “assumed response time (RT)”. Then, the parameter adjustment unit 250 may calculate new “waiting time (ST)” using the measured “average response time (RT_{AVE})” as “RT” in [Formula 2] or [Formula 4].

The parameter storage unit 120 may store a representative value other than the average value as a parameter of “thinking time (TT)” or “waiting time (ST)”.

The response time acquisition unit 240 may acquire a representative value other than “average response time (RT_{AVE})”.

The parameter storage unit 120 may not necessarily receive all the parameters from an operator.

For example, the “minimum thinking time (TT_{MIN})” or “minimum waiting time (ST_{MIN})” may be set to sufficiently large values with reference to the tick of the OS in advance. Further, the “minimum thinking time (TT_{MIN})” or “minimum waiting time (ST_{MIN})” may be determined in a format such as “a value that is an integer multiple of OS tick”.

When generating virtual users, the generation unit 230 may collectively control event processing of each virtual user (for example, transmission and reception of requests and resumption from stop) according to the scheduled generation time. In such a case, the generation unit 230 can simulate parallel operation of virtual users even without generating a plurality of threads or processes.

Further, the generation unit 230 may prepare a plurality of kinds of test scenarios, and execute each scenario at a predetermined probability. When a plurality of kinds of test scenarios are prepared, for example, the load test execution device 10 can calculate expectation of “the number of requests included in the test scenario (N)” based on the number of requests included in each test scenario (N) and the probability of selecting each scenario.

In the description of the above-described first exemplary embodiment, the “waiting time (ST)” is defined as time from when a virtual user receives the response to the last request of a test scenario and disconnects a TCP connection until when the virtual user executes the test scenario again, establishes a TCP connection, and transmits the first request. However, in a variation of the first exemplary embodiment, the test scenario may embed “waiting time (ST)” during which a TCP connection is disconnected. In such a case, the test storage unit 110 may store a test scenario that includes “waiting time (ST)” at least once in the repetition of transmission of requests and response to the requests.

### Second Exemplary Embodiment

A load test execution device 11 according to a second exemplary embodiment of the present invention will be described in detail with reference to the drawings.

<Description of Configuration>

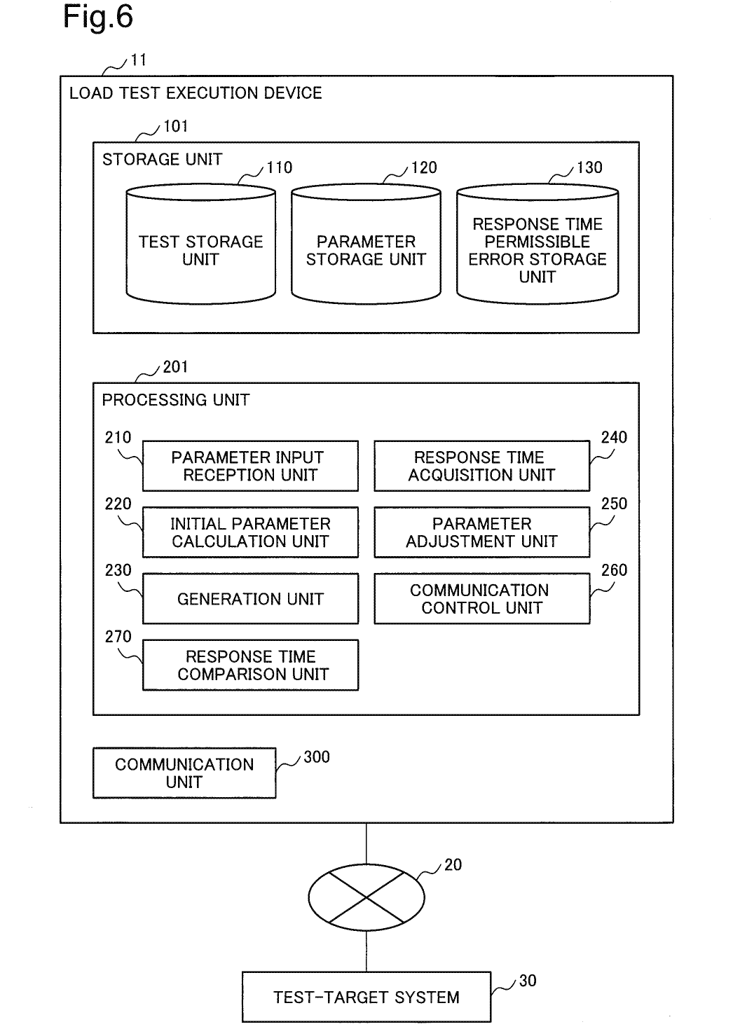

FIG. 6 is a block diagram depicting an example of a network configuration that includes the load test execution device 11 according to the second exemplary embodiment.

The load test execution device 11 according to the second exemplary embodiment includes a storage unit 101, a processing unit 201, and a communication unit 300.

The storage unit 101 includes a response time permissible error storage unit 130 in addition to the configuration included in the storage unit 100 according to the first exemplary embodiment.

The processing unit 201 includes a response time comparison unit 270 in addition to the configuration included in the processing unit 200 according to the first exemplary embodiment.

The response time permissible error storage unit 130 stores a “response time permissible error”.

For example, the “response time permissible error” is stored in a percentage value format such as “5%” or an absolute value format such as “0.05 seconds”. The “response time permissible error” is a value that is permitted in relation to a difference between the “assumed response time (RT)” stored in the parameter storage unit 120 and the “average response time (RT_{AVE})” that the response time acquisition unit 240 acquired. The “response time permissible error” is accepted by the parameter input reception unit 210 as a parameter from the operator, and stored in the response time permissible error storage unit 130.

The response time comparison unit 270 calculates a difference between the “assumed response time (RT)” stored in the parameter storage unit 120 and the “average response time (RT_{AVE})” that the response time acquisition unit 240 acquired. Then, the response time comparison unit 270 judges whether or not the difference is within the range of the “response time permissible error” stored in the response time permissible error storage unit 130. When the difference of both is judged as not within the range of the permissible error, the response time comparison unit 270 instructs the parameter adjustment unit 250 to recalculate the “waiting time (ST)”.

<Description of Operation>

Next, the following will describe the operation of the load test execution device 11 according to the second exemplary embodiment.

Description is omitted for the operation of determining the initial values of parameters, as the operation is the same as the one of the load test execution device 10 according to the first exemplary embodiment. Thus, the operation of adjusting a parameter while executing a load test will be described in detail.

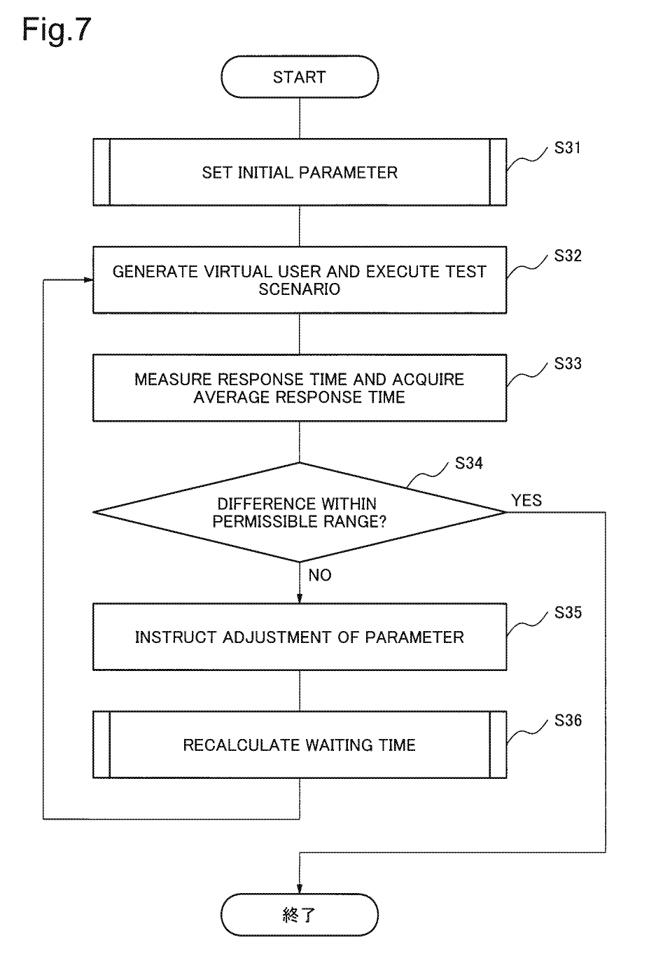

FIG. 7 is a flowchart depicting the operation in which the load test execution device 11 according to the second exemplary embodiment adjusts parameters while performing a load test.

Description of the processing of S31, S32, and S33 according to the second exemplary embodiment is omitted, as the processing is the same as the processing (S21 to S23) of the load test execution device 10 according to the first exemplary embodiment.

The response time comparison unit 270 calculates a difference between the “average response time (RT_{AVE})” that the response time acquisition unit 240 acquired and the “assumed response time (RT)” stored in the parameter storage unit 120, and judges whether or not the difference is within the range of the “response time permissible error” (S34).

As the result of judgment, when the difference of both is within the range of the “response time permissible error” (YES at S34), the response time comparison unit 270 continues a load test without instructing the parameter adjustment unit 250 with regard to the “waiting time (ST)”.

When the difference of both is not within the range of the “response time permissible error” (NO at step S34), the response time comparison unit 270 instructs the parameter adjustment unit 250 to recalculate the “waiting time (ST)” (S35).

The parameter adjustment unit 250 recalculates the value of “waiting time (ST)” (S36).

The processing at S36 in the second exemplary embodiment is the same as the processing of the load test execution device 10 according to the first exemplary embodiment.

The processing at S34 will be described in detail.

Here, for example, it is supposed that the “response time permissible error” is given as “0.05 seconds”, the “assumed response time (RT)” stored in the parameter storage unit 120 is “1 second”, and the “average response time (RT_{AVE})” that the response time acquisition unit 240 acquired is “1.2 seconds”.

In such a case, the response time comparison unit 270 calculates the difference of both as “0.2 seconds”.

Next, the response time comparison unit 270 compares the calculated difference of “0.2 seconds” with the “response time permissible error” of “0.05 seconds”. In this case, the response time comparison unit 270 judges that the difference exceeds the “response time permissible error”. Accordingly, the response time comparison unit 270 instructs the parameter adjustment unit 250 to recalculate “waiting time (ST)” based on the “average response time (RT_{AVE})” that the response time acquisition unit 240 acquired.

In addition, the load test execution device 11 may define a situation where a difference between the “assumed response time (RT)” and the “average response time (RT_{AVE})” successively falls within the range of the “response time permissible error” for a predetermined number of times or more as a termination condition of a load test.

As a variation of the second exemplary embodiment, the load test execution device 11 may treat the value input by the operator as the “assumed response time (RT)” instead of the “assumed response time (RT)” that is stored in the parameter storage unit 120.

As such, the load test execution device 11 according to the second exemplary embodiment can generate a load that is faithful to the desired value.

This is because the load test execution device 11 executes resetting of “waiting time (ST)” based on a difference between the “assumed response time (RT)” and the “average response time (RT_{AVE})”.

Further, the load test execution device 11 can appropriately repeat execution of a test scenario.

This is because the load test execution device 11 can end a load test when a difference between the “assumed response time (RT)” and the “average response time (RT_{AVE})” successively falls within the range of the “response time permissible error” for a predetermined number of times or more.

### Third Exemplary Embodiment

A load test execution device 12 according to a third exemplary embodiment of the present invention will be described in detail with reference to the drawings.

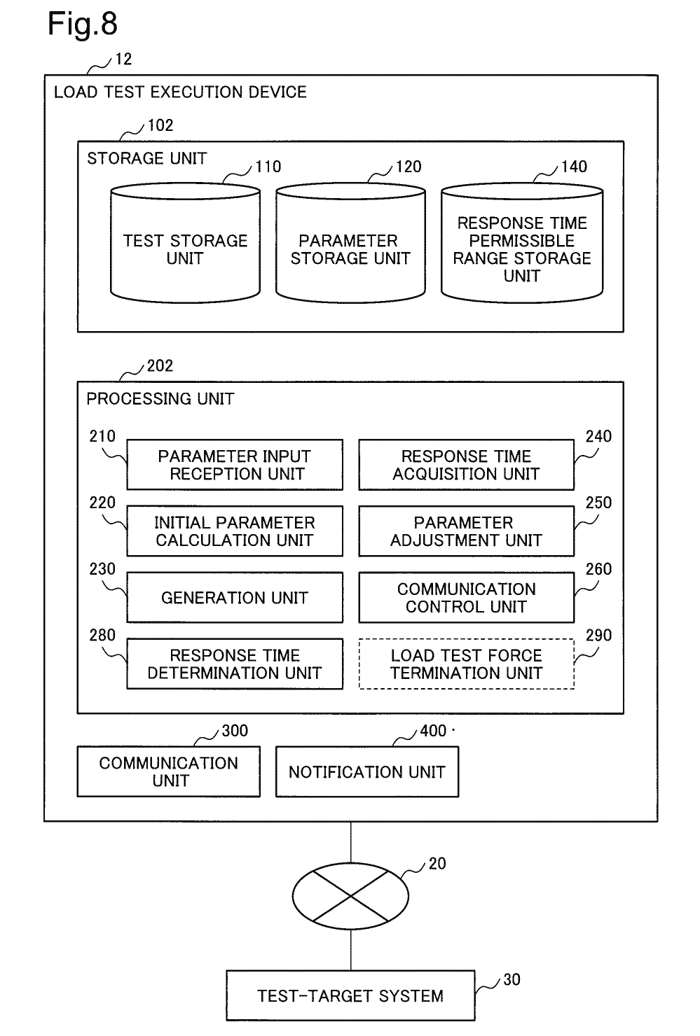

FIG. 8 is a block diagram depicting an example of a network configuration that includes the load test execution device 12 according to the third exemplary embodiment.

The load test execution device 12 according to the third exemplary embodiment includes a storage unit 102, a processing unit 202, a communication unit 300, and a notification unit 400.

The storage unit 102 includes a response time permissible range storage unit 140 in addition to the configuration included in the storage unit 100 according to the first exemplary embodiment.

The processing unit 202 includes a response time judgment unit 280 in addition to the configuration included in the processing unit 200 according to the first exemplary embodiment.

The response time permissible range storage unit 140 stores “assumed minimum response time (RT_{MIN})” and “assumed maximum response time (RT_{MAX})”.

The response time judgment unit 280 judges whether or not the “average response time (RT_{AVE})” that the response time acquisition unit 240 acquired is within a predetermined range, for example, within a range from the “assumed minimum response time (RT_{MIN})” to the “assumed maximum response time (RT_{MAX})”.

After judgment of the response time judgment unit 280, if the “average response time (RT_{AVE})” is out of the range from the “assumed minimum response time (RT_{MIN})” to the “assumed maximum response time (RT_{MAX})”, the notification unit 400 notices the effect thereof to an external device that is not depicted (for example, a device operated by an operator).

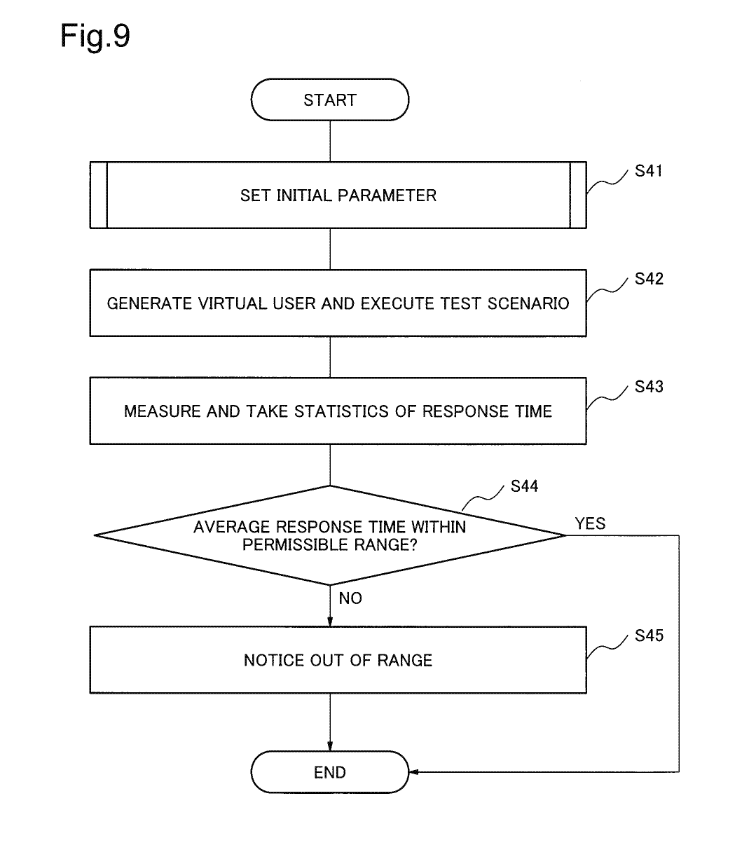

FIG. 9 is a flowchart depicting an example of operation of the load test execution device 12 according to the third exemplary embodiment.

Description of the processing of S41, S42, and S43 according to the third exemplary embodiment is omitted, as the processing is the same as the operation (S21 to S23) of the load test execution device 10 according to the first exemplary embodiment.

The response time judgment unit 280 judges whether or not the “average response time (RT_{AVE})” that the response time acquisition unit 240 acquired is within a range from the “assumed minimum response time (RT_{MIN})” to the “assumed maximum response time (RT_{MAX})” (S44).

If the “average response time (RT_{AVE})” is within the range (YES at S44), the load test execution device 12 continues the load test.

If the “average response time RT_{AVE})” is out of the range (NO at S44), the notification unit 400 notices the effect that the “average response time” is out of the range (S45).

Here, the effects provided by the load test execution device 13 according to the third exemplary embodiment will be described.

When the “average response time (RT_{AVE})” is shorter than the assumed minimum response time RT_{MIN}, more than necessary number of requests are transmitted to the test-target system 30. There is a case in which the operation of the test-target system 30 is unstable when a load beyond assumption is applied thereon. In the worst case, the test-target system 30 stops. When the test-target system 30 stops, it is necessary to reboot the test-target system 30 for continuance of the load test. As a result, efficiency in execution of the test decreases.

On the other hand, when the “average response time (RT_{AVE})” is longer than the “assumed maximum response time (RT_{MAX})”, the response time of the test-target system 30 exceeds assumption regardless of the request arrival rate that is lower than assumption. As such, it becomes immediately clear that the test-target system 30 does not demonstrate the desired performance.

In this way, the load test execution device 12 according to the third exemplary embodiment can notice these unfavorable conditions, for example, to the operator based on the notice from the notification unit 400.

This is because the response time judgment unit 280 of the load test execution device 12 judges whether or not the “average response time (RT_{AVE})” is within an appropriate range. Then, if out of the range, the notification unit 400 notices the effect thereof.

As a variation of the third exemplary embodiment, the load test execution device 12 may include a load test force termination unit 290 instead of the notification unit 400.

The load test force termination unit 290 forcibly terminates the load test when the “average response time (RT_{AVE})” is not within a predetermined range as the result of judgment of the response time judgment unit 280.

Therefore, the load test execution device 12 according to the variation of the third exemplary embodiment can automatically terminate a load test when the load test is inappropriate.

### Fourth Exemplary Embodiment

The load test execution device 13 according to a fourth exemplary embodiment of the present invention will be described in detail with reference to the drawings.

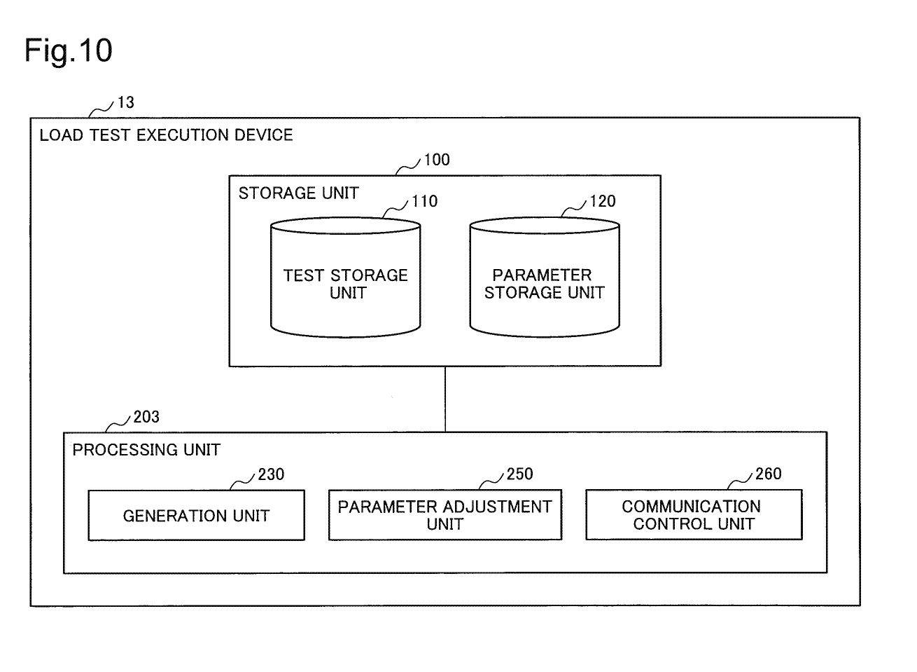

FIG. 10 is a block diagram depicting an example of a configuration of the load test execution device 13 according to the fourth exemplary embodiment.

The load test execution device 13 according to the fourth exemplary embodiment includes a storage unit 100 that includes a test storage unit 110 and a parameter storage unit 120, and a processing unit 203 that includes a generation unit 230, a parameter adjustment unit 250, and a communication control unit 260.

These configurations are the same as the first exemplary embodiment. Thus, though it becomes a repetition, each configuration will be described.

The test storage unit 110 stores a test scenario (hereinafter, referred to as the “script” in the description of the fourth exemplary embodiment). The script includes processing from transmitting a request until receiving the response to the request for a plurality of times. The time between reception and transmission is “waiting time” during which a TCP connection is disconnected or “thinking time” during which a TCP connection is preserved.

The generation unit 230 generates load generation means (a virtual user) that applies a load, by executing a script, on a target system applied the load (for example, a test-target system 30 depicted in FIG. 1).

The parameter storage unit 120 stores a parameter that defines length of “waiting time (ST)”.

The parameter adjustment unit 250 adjusts a parameter so that the desired number of requests per unit time arrive at the system.

The communication control unit 260 preserves a channel (a TCP connection) during “thinking time (TT)” included in the script that the load generation means is executing and disconnects a channel (a TCP connection) during “waiting time (ST)” included therein.

The load test execution device 13 of the fourth exemplary embodiment configured in this way can realize the same effects as the load test execution device 10 of the first exemplary embodiment.

This is because, as described above, the load test execution device 13 can adjust parameters so as to execute an appropriate load test.

In addition, the load test execution device 13 is the minimum configuration of the present invention.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2012-079418, filed on Mar. 30, 2012, the disclosure of which is incorporated herein in its entirety by reference.

### INDUSTRIAL APPLICABILITY

The present invention is suitable for a load test execution device, a load test execution system, or a load test execution method for verifying performance and behavior of a test-target system when a predetermined load is applied thereon.

### REFERENCE SIGNS LIST

10 Load test execution device
11 Load test execution device
12 Load test execution device
13 Load test execution device
20 Network
30 Test-target system
100 Storage unit
101 Storage unit
102 Storage unit
110 Test storage unit
120 Parameter storage unit
130 Response time permissible error storage unit
140 Response time permissible range storage unit
200 Processing unit
201 Processing unit
202 Processing unit
203 Processing unit
210 Parameter input reception unit
220 Initial parameter calculation unit
230 Generation unit
240 Response time acquisition unit
250 Parameter adjustment unit
260 Communication control unit
270 Response time comparison unit
280 Response time judgment unit
290 Load test force termination unit
300 Communication unit
400 Notification unit

What is claimed is:

1.-10. (canceled)

11. An information processing device comprising:
a test storage unit which stores a test scenario that includes processing from transmitting a request until receiving a response to the request for a plurality of times and in which time between the reception and the transmission is waiting time during which a TCP connection is disconnected or thinking time during which the TCP connection is preserved;
a generation unit which generates load generation means that applies a load on a system as a subject of applying the load by executing the test scenario;
a parameter storage unit which stores a parameter that defines length of the waiting time;
a parameter adjustment unit which adjusts the parameter so that a desired number of requests arrive at the system per unit time; and
a communication control unit which preserves the TCP connection during the thinking time included in the test scenario that the load generation means is executing and disconnecting the TCP connection during the waiting time.

12. The information processing device according to claim 11, wherein
the communication control unit defines the waiting time by interval between last reception included in the test scenario that the load generation means is executing and first transmission included in a next test scenario.

13. The information processing device according to claim 11, wherein
the test storage unit stores a test scenario that includes the waiting time at least once during the processing for the plurality of times.

14. The information processing device according to claim 11, further comprising:
a response time acquisition unit which acquires a response time representative value that is a representative value of time from when the load generation means transmits a request until when the load generation means receives a response to the request, wherein
the parameter storage unit further stores the response time representative value,
the response time acquisition unit updates the response time representative value stored in the parameter storage unit when acquiring the response time representative value, and
the parameter adjustment unit calculates a new parameter value based on: a value of the parameter stored in the parameter storage unit, the response time representative value stored in the parameter storage unit, and the response time representative value that the response time acquisition unit newly acquired.

15. The information processing device according to claim 11, further comprising:
a parameter input reception unit which accepts an input of a maximum value that is permitted as the response time representative value, wherein
the number of the load generation means to be generated by the generation unit is determined based on the maximum value that is permitted as the response time representative value.

16. The information processing device according to claim 15, wherein
an initial value of the parameter is determined based on a minimum value assumed as the response time representative value that the parameter input reception unit received or an assumption that the response time representative value is zero second.

17. The information processing device according to claim 14, further comprising:
a response time comparison unit which calculates a difference between the response time representative value stored in the parameter storage unit and the response time representative value acquired by the representative acquisition unit; and
a response time permissible error storage unit which stores a permissible range of the difference; wherein
the response time comparison unit judges whether or not the difference falls within the permissible range of the difference, and
the parameter adjustment unit calculates a new parameter value when the difference is out of the permissible range of the difference.

18. The information processing device according to claim 14, further comprising:
a response time permissible range storage unit which stores a minimum value and a maximum value that are permitted as the response time representative value;
a response time judgment unit which judges whether or not the response time representative value acquired by the response time acquisition unit is within a range from the minimum value to the maximum value; and
a notification unit which notifies a result of judgment of the response time judgment unit.

19. A control method of a test load device comprising:
storing a test scenario that includes processing from transmitting a request until receiving a response to the request for a plurality of times and in which time between the reception and the transmission is waiting time, during which a TCP connection is disconnected, or thinking time, during which the TCP connection is preserved;
generating load generation means that applies a load, by executing the test scenario, on a system as a subject of applying the load, and applying the load on the system as the subject of applying the load;
storing a parameter that defines length of the waiting time;
adjusting the parameter so that a desired number of requests arrive at the system per unit time; and
preserving the TCP connection during thinking time included in the test scenario that the load generation means is executing, and disconnecting the TCP connection during waiting time.

20. A non-transitory computer readable medium embodying a program, said program causing a load test device to perform a method, said method comprising:
storing a test scenario that includes processing from transmitting a request until receiving a response to the request for a plurality of times and in which time between the reception and the transmission is waiting time during which a TCP connection is disconnected or thinking time during which the TCP connection is preserved;
generating load generation means that applies a load, by executing the test scenario, on a system as a subject of applying the load, and applies the load on the system as the subject of applying the load;
storing a parameter that defines length of the waiting time;
adjusting the parameter so that a desired number of requests arrive at the system per unit time; and
preserving the TCP connection during thinking time included in the test scenario that the load generation means is executing and disconnecting the TCP connection during waiting time included therein.
